(19) United States
(12) Patent Application Publication
(10) Pub. No.: US 2016/0033348 A1
(43) Pub. Date: Feb. 4, 2016

(54) PRESSURE TRANSDUCER

(71) Applicant: Yi-Lin Motor Parts Co., Ltd., Changhua County (TW)

(72) Inventor: Fang-Pin HO, Changhua County (TW)

(21) Appl. No.: 14/446,597

(22) Filed: Jul. 30, 2014

(51) Int. Cl. G01L 9/00

(52) U.S. Cl. CPC G01L 9/0041

(57) ABSTRACT

A pressure transducer includes a substrate which is an aluminum substrate to enhance the strength and heat dissipation of the pressure transducer and prevent the substrate from being deformed by heat, and both sides of the substrate have top and bottom circuit board portions in conformity with a control circuit board which is a flexible printed circuit board, so as to achieve the effects of simplifying the structure and manufacturing process, reducing the production cost, improving the product stability and lowering the using cost.

### FIELD OF THE INVENTION

The present invention relates to the field of pressure detection devices, in particular to a pressure transducer.

### BACKGROUND OF THE INVENTION

With reference to FIG. 6 for a conventional pressure transducer, the conventional pressure transducer comprises an upper casing 30, a lower casing 40 and a substrate 50, and the upper casing 30 includes a pressure guide hole 31, and the lower casing 40 includes a plurality of conductive terminals 41, and the substrate 50 includes a transducer 51, a conversion circuit 52 and a metal wire 53 installed thereon, and the transducer 51 is electrically coupled to the conversion circuit 52 by the metal wire 53, and the substrate 50 is made of ceramic or insulating resin and sealed between the upper casing 30 and the lower casing 40, and the transducer 51 is installed at a position opposite to a pressure guide hole 31 of upper casing 30. When the pressure produced by a gas or a liquid is introduced from the pressure guide hole 31 of the upper casing 30 and detected by the transducer 53 of the substrate 50, and the pressure detection result is converted into an electric signal by the conversion circuit 52 and the electric signal is outputted to the plurality of conductive terminals 41 of the lower casing 40 in order to detect the gas or liquid pressure, but the conventional gas and liquid pressure detector has the following problems:

Poor Product Stability: If the substrate is made of insulating resin, the substrate may be deformed by overheat easily and has a poor heat dissipation effect. After a long time of use, the detection accuracy drops due to the change of environmental factors, so that the product stability is poor.

High Using Cost: If the substrate is made of ceramic, the substrate will have the advantages of high resistance and good chemical stability, but the ceramic substrate incurs a higher production cost, so that the using cost is high.

### SUMMARY OF THE INVENTION

In view of the aforementioned problems including the poor product stability and high using cost of the conventional pressure transducer made of a ceramic or insulating resin substrate, the inventor of the present invention based on years of experience in the related industry to conduct extensive researches and experiment, and finally developed a pressure transducer in accordance with the present invention to overcome the problems of the prior art.

Therefore, it is a primary objective of the present invention to provide a pressure transducer comprising a substrate, a control circuit board, an upper casing and a lower casing, wherein the upper casing has a pressure guide hole, and the upper casing has an O-ring installed thereon, and the lower casing has a plurality of conductive terminals electrically conducted with the lower casing, and the substrate is electrically coupled to the circuit board and sealed between the upper casing and the lower casing, characterized in that the substrate is an aluminum substrate, and the substrate includes a top circuit board portion and a bottom circuit board portion, and the top circuit board portion includes a plurality of top-side printed contact units, a plurality of printed circuit units and a pressure sensing unit, and the pressure sensing unit is electrically coupled to the printed circuit unit, and the pressure sensing unit is disposed opposite to the pressure guide hole of the upper casing, and the bottom circuit board portion has a plurality of bottom-side printed contact units disposed opposite to the plurality of top-side printed contact units of the top circuit board portion respectively. In addition, the control circuit board is a flexible printed circuit (FPC) board, and the control circuit board has a signal control circuit portion, an extended circuit portion and a conductive circuit portion, and the signal control circuit portion is electrically coupled to the plurality of bottom-side printed contact units installed at the bottom circuit board portion of the substrate, and the conductive circuit portion is electrically coupled to the plurality of conductive terminals of the lower casing. The aforementioned electric connection is achieved by soldering. The aluminum substrate also enhances the strength and heat dissipation of the product and prevents the substrate from being deformed by heat. The substrate has the top and bottom circuit board portions disposed on both sides of the substrate respectively. The control circuit board being a FPC board, and thus the invention can simplify the structure and manufacturing process effectively, so as to achieve the effects of lowering the production cost, improving the product stability, and reducing the using cost.

### BRIEF DESCRIPTION OF THE DRAWINGS

FIG. 1 is a perspective view of the present invention;

FIG. 2 is an exploded view of the present invention;

FIG. 3 is a sectional side view of the present invention;

FIG. 4 is a top view of a substrate and a control circuit board electrically coupled to each other in accordance with the present invention;

FIG. 5 is a bottom view of a substrate and a control circuit board electrically coupled to each other in accordance with the present invention; and

FIG. 6 is a schematic view of a conventional pressure transducer.

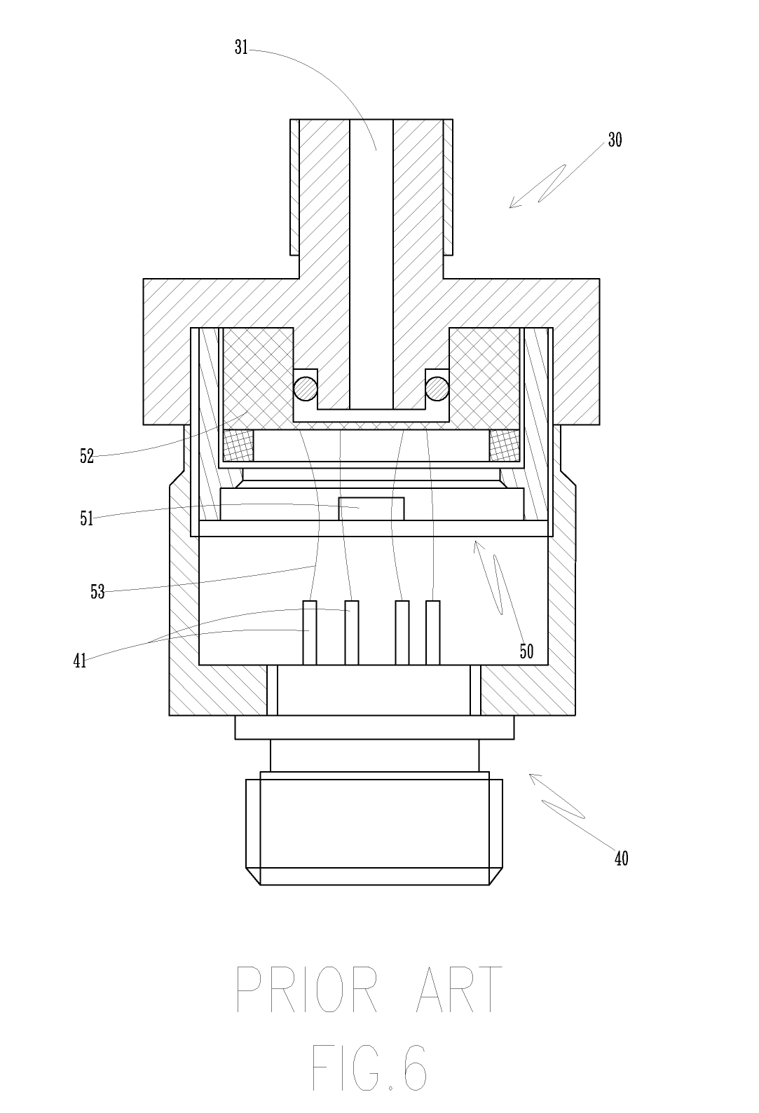

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

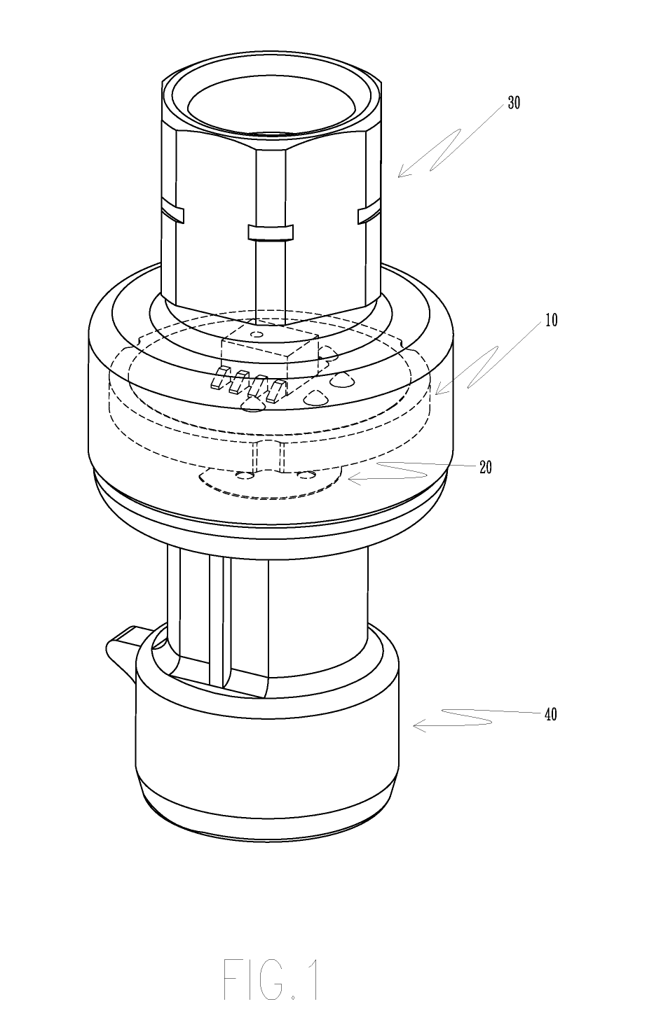

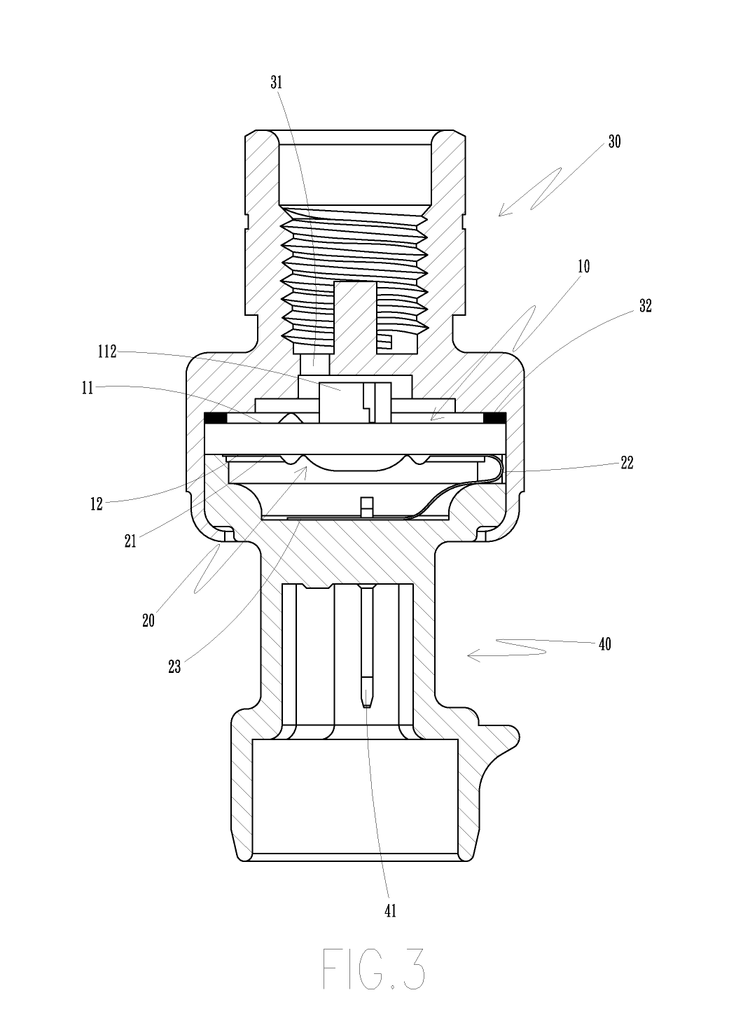

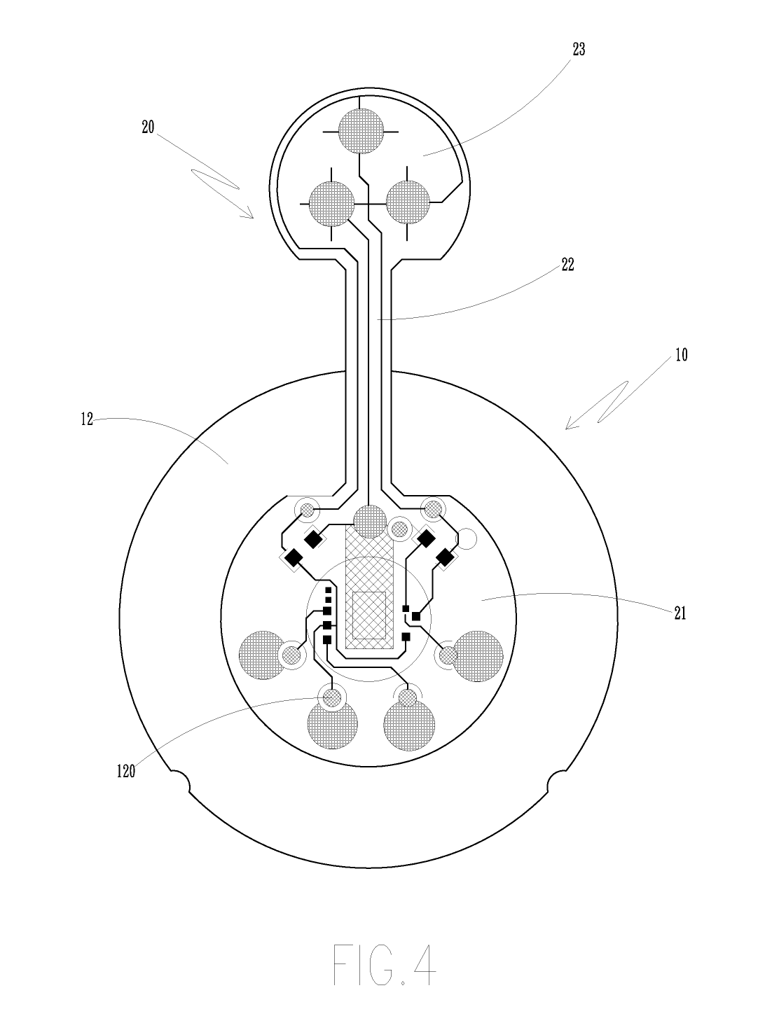

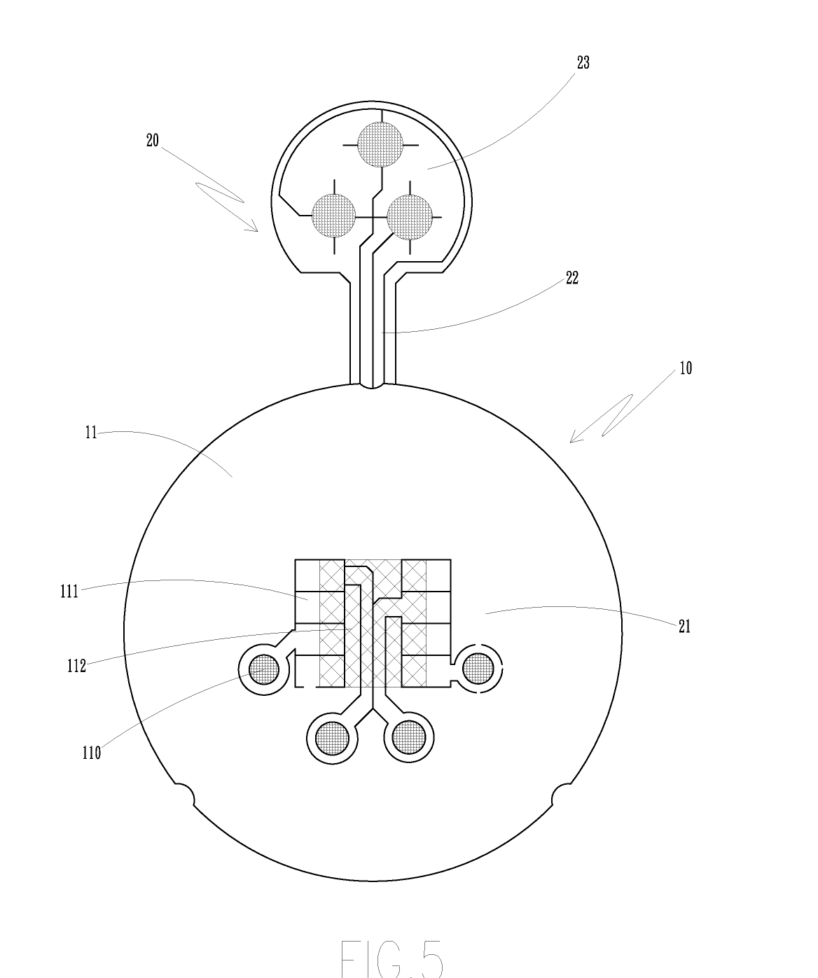

With reference to FIGS. 1 to 5 for a perspective view, an exploded view, and a sectional side view of a pressure transducer of the present invention and a top view and a bottom view of a substrate and a control circuit board electrically coupled with each other in accordance with the present invention respectively, the pressure transducer comprises a substrate 10, a control circuit board 20, an upper casing 30 and a lower casing 40. The upper casing 30 has a pressure guide hole 31, and an O-ring 32 installed in the upper casing 30. The lower casing 40 has a plurality of conductive terminals 41 electrically conducted with the lower casing 40, and the substrate 10 is electrically coupled to the control circuit board 20 and sealed between the upper casing 30 and the lower casing 40, characterized in that the substrate 10 is an aluminum substrate, and the substrate 10 includes a top circuit board portion 11 and a bottom circuit board portion 12, and the top circuit board portion 11 includes a plurality of top-side printed contact units 110, a plurality of printed circuit units 111 and a pressure sensing unit 112, and the pressure sensing unit 112 is electrically coupled to the printed circuit unit 111, and the pressure sensing unit 112 is disposed opposite to the pressure guide hole 31 of the upper casing 30, and the bottom circuit board portion 12 has a plurality of bottom-side printed contact units 120 disposed opposite to the plurality of top-side printed contact units 110 of the top circuit board portion 11. In addition, the control circuit board 20 is a flexible printed circuit (FPC) board, and the control circuit board 20 includes a signal control circuit portion 21, an extended circuit portion 22 and a conductive circuit portion 23, and the signal control circuit portion 21 is electrically coupled to the plurality of bottom-side printed contact units 120 installed at the bottom circuit board portion 12 of the substrate 10, and the conductive circuit portion 23 is electrically coupled to the plurality of conductive terminals 41 of the lower casing 40, and the aforementioned electric connection is achieved by soldering.

With the aforementioned structure, the pressure transducer of the present invention is produced.

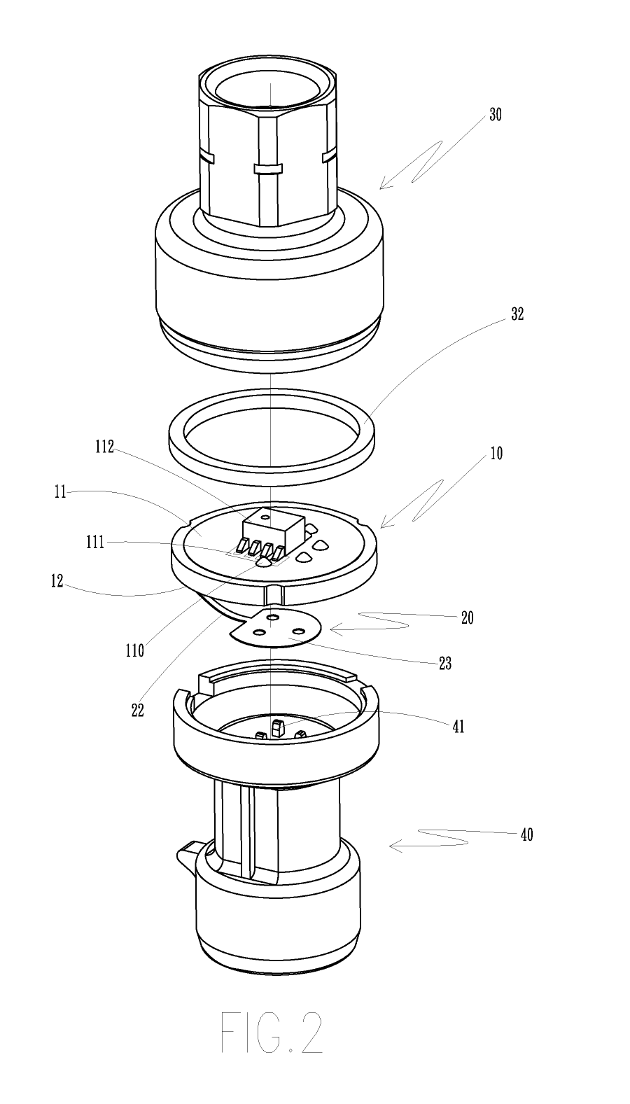

With reference to FIGS. 2 to 5 for an exploded view, and a sectional side view of a pressure transducer of the present invention and a top view and a bottom view of a substrate being electrically coupled to a control circuit board respectively, the substrate 10 is an aluminum substrate and the substrate 10 includes a top circuit board portion 11 and a bottom circuit board portion 12, and the top circuit board portion 11 includes a plurality of top-side printed contact units 110, a plurality of printed circuit units 111 and a pressure sensing unit 112, and the pressure sensing unit 112 is electrically coupled to the printed circuit unit 111, and the pressure sensing unit 112 is disposed opposite to the pressure guide hole 31 of the upper casing 30, and the bottom circuit board portion 12 has a plurality of bottom-side printed contact units 120 disposed opposite to the plurality of top-side printed contact units 110 of the top circuit board portion 11 respectively, and the control circuit board 20 is a flexible printed circuit (FPC) board, and the control circuit board 20 includes a signal control circuit portion 21, an extended circuit portion 22 and a conductive circuit portion 23, and the signal control circuit portion 21 is electrically coupled to the a plurality of bottom-side printed contact units 120 installed at the bottom circuit board portion 12 of the substrate 10, and the conductive circuit portion 23 is electrically coupled to the plurality of conductive terminals 41 of the lower casing 40, and the substrate 10 is an aluminum substrate capable of improving the strength and heat dissipation of the product and prevent the substrate from being deformed by heat, and top and bottom circuit board portions 11, 12 are formed on both sides of the substrate 10 respectively and in conformity with the control circuit board 20 which is a PFC board, and thus the invention can achieve the effects of simplifying the structure and manufacturing process, reducing the production cost, improving the product stability and lowering the using cost.

Therefore, the present invention has the following advantages:

1. Good Product Stability: The substrate is an aluminum substrate capable of improving the strength and heat dissipation of the product and preventing the substrate from being deformed by heat, so that the product stability is good.

2. Low Using Cost: The top and bottom circuit board portions are formed on both sides of the substrate and in conformity with the control circuit board which is a FPC board, so that the invention achieves the effect of simplifying the structure and manufacturing process, reducing the production cost and lowering the using cost.

In summation of the description above, the present invention achieves the aforementioned functions and objectives and complies with patent application requirements, and thus is duly filed for patent application.

What is claimed is:

1. A pressure transducer, comprising:
a substrate, being an aluminum substrate, and having a top circuit board portion and a bottom circuit board portion, and the top circuit board portion including a plurality of top-side printed contact units, a plurality of printed circuit units and a pressure sensing unit, and the pressure sensing unit being electrically coupled to the printed circuit unit, and the bottom circuit board portion having a plurality of bottom-side printed contact units disposed opposite to the plurality of top-side printed contact units of the top circuit board portion respectively; and
a control circuit board, being a flexible printed circuit board, and having a signal control circuit portion, an extended circuit portion and a conductive circuit portion, and the signal control circuit portion being electrically coupled to a plurality of bottom-side printed contact units installed at the bottom circuit board portion of the substrate.

2. The pressure transducer according to claim 1, wherein the control circuit board is a flexible printed circuit (FPC) board.

3. A pressure transducer, comprising a substrate, a control circuit board, an upper casing and a lower casing, and the upper casing having a pressure guide hole being electrically conducted to the upper casing, and the upper casing having an O-ring installed therein, and the lower casing having a plurality of conductive terminals, and the substrate being electrically coupled to the circuit board and sealed between the upper casing and the lower casing, characterized in that the substrate is an aluminum substrate, and the substrate includes a top circuit board portion and a bottom circuit board portion, and the top circuit board portion includes a plurality of top-side printed contact units, a plurality of printed circuit units and a pressure sensing unit, and the pressure sensing unit is electrically coupled to the printed circuit unit, and the pressure sensing unit is disposed opposite to a pressure guide hole of the upper casing, and the bottom circuit board portion includes a plurality of bottom-side printed contact units disposed opposite to the plurality of top-side printed contact units of the top circuit board portion respectively, and the control circuit board is a flexible printed circuit board, and the control circuit board includes a signal control circuit portion, an extended circuit portion and a conductive circuit portion, and the signal control circuit portion is electrically coupled to the plurality of bottom-side printed contact units installed at the bottom circuit board portion of the substrate, and the conductive circuit portion is electrically coupled to the plurality of conductive terminals of the lower casing.

4. The pressure transducer according to claim 3, wherein the control circuit board is a flexible printed circuit (FPC) board.
